(19) United States
(12) Patent Application Publication
(10) Pub. No.: US 2024/0357233 A1
(43) Pub. Date: Oct. 24, 2024

(54) IMAGING METHOD, IMAGING APPARATUS, AND PROGRAM

(71) Applicant: FUJIFILM Corporation, Tokyo (JP)

(72) Inventor: Yuma KOMIYA, Saitama-shi (JP)

(73) Assignee: FUJIFILM Corporation, Tokyo (JP)

(21) Appl. No.: 18/759,986

(22) Filed: Jun. 30, 2024

Related U.S. Application Data
(63) Continuation of application No. PCT/JP2022/044973, filed on Dec. 6, 2022.

(30) Foreign Application Priority Data
Jan. 24, 2022 (JP) 2022-008988

(51) Int. Cl. H04N 23/67; G03B 13/36; H04N 23/611

(52) U.S. Cl. CPC H04N 23/67; G03B 13/36; H04N 23/611

(57) ABSTRACT

There is provided an imaging method including: an imaging step of generating image data by an imaging element; a detection step of detecting a first range including a subject that is a focusing target from the image data; a determination step of determining an attribute of the subject; and a decision step of deciding whether a size of a second range for acquiring distance information of the subject is set to be within the first range or to exceed the first range, based on the attribute.

### CROSS-REFERENCE TO RELATED APPLICATION

This application is a continuation application of International Application No. PCT/JP2022/044973, filed Dec. 6, 2022, the disclosure of which is incorporated herein by reference in its entirety. Further, this application claims priority from Japanese Patent Application No. 2022-008988 filed on Jan. 24, 2022, the disclosure of which is incorporated herein by reference in its entirety.

### BACKGROUND

### 1. Technical Field

The technology of the present disclosure relates to an imaging method, an imaging apparatus, and a program.

### 2. Description of the Related Art

JP2009-098317A discloses an imaging apparatus that prevents occurrence of erroneous focusing due to an image of a background included in an autofocus target region in a case of executing autofocus using an autofocus target region decided based on a face region obtained by performing face detection. A face detection unit performs face detection to specify a face region including an image of a face of a person. An AF target region decision unit decides an AF target region from the face region. The AF target region decision unit can change an area ratio of the AF target region to the face region. An AF evaluation value calculation unit, a controller, and a lens drive unit adjust an image formation position of a subject image by an imaging optical system based on contrast of image data which is obtained by imaging and corresponds to the AF target region decided by the AF target region decision unit.

JP2021-132362A discloses a subject tracking device that can reduce erroneous tracking of a subject. The subject tracking device described in JP2021-132362A includes an image acquisition unit that sequentially acquires images, a tracking unit that tracks a subject detected from an image acquired by the image acquisition unit through comparison between images over a plurality of images sequentially acquired by the image acquisition unit, and a switching unit that switches a time for continuing the tracking in the tracking unit according to a type of the subject detected from the image.

### SUMMARY

One embodiment according to the technology of the present disclosure provides an imaging method, an imaging apparatus, and a program capable of improving focusing accuracy on a subject that is a focusing target.

In order to achieve the above object, according to the present disclosure, there is provided an imaging method including: an imaging step of generating image data by an imaging element; a detection step of detecting a first range including a subject that is a focusing target from the image data; a determination step of determining an attribute of the subject; and a decision step of deciding whether a size of a second range for acquiring distance information of the subject is set to be within the first range or to exceed the first range, based on the attribute.

Preferably, the detection step and the determination step are performed by using a machine-learned model.

Preferably, the imaging method further includes: an acquisition step of acquiring the distance information of the subject in the second range; and a focusing step of bringing the subject into a focusing state based on the distance information.

Preferably, in the determination step, whether the attribute of the subject corresponds to which object among two or more types of objects is determined, or whether the attribute of the subject corresponds to which part of which object among two or more types of objects is determined.

Preferably, the object is a person, an animal, a bird, a train, a car, a motorcycle, a ship, or an airplane.

Preferably, in the decision step, the size of the second range varies in a case where it is determined in the determination step that the attribute is a first part of a first object and in a case where it is determined in the determination step that the attribute is a first part of a second object.

Preferably, in the focusing step, a continuous focusing mode in which a focusing operation is continuously performed is selectively executable as a focusing mode, and in the decision step, the size of the second range varies depending on whether or not the focusing mode is the continuous focusing mode.

Preferably, the decision step includes a correction step of correcting the size of the second range.

Preferably, in the correction step, the size of the second range is corrected based on a state of the subject, whether or not the subject is a moving object, or reliability of determination of the attribute.

Preferably, in the correction step, in a case where the size of the second range exceeds a first threshold value, the second range is reduced, and in a case where the size of the second range is smaller than a second threshold value which is smaller than the first threshold value, the second range is enlarged.

According to the present disclosure, there is provided an imaging apparatus including: an imaging element that generates image data; and a processor, in which the processor is configured to execute: detection processing of detecting a first range including a subject that is a focusing target from the image data; determination processing of determining an attribute of the subject; and decision processing of deciding whether a size of a second range for acquiring distance information of the subject is set to be within the first range or to exceed the first range, based on the attribute.

According to the present disclosure, there is provided a program causing a computer to execute: detection processing of detecting a first range including a subject that is a focusing target from the image data; determination processing of determining an attribute of the subject; and decision processing of deciding whether a size of a second range for acquiring distance information of the subject is set to be within the first range or to exceed the first range, based on the attribute.

### BRIEF DESCRIPTION OF THE DRAWINGS

Exemplary embodiments according to the technique of the present disclosure will be described in detail based on the following figures, wherein:

FIG. 1 is a diagram illustrating an example of an internal configuration of an imaging apparatus,

FIG. 2 is a diagram illustrating an example of a light-receiving surface of an imaging sensor,

FIG. 3 is a block diagram illustrating an example of a functional configuration of a processor,

FIG. 4 is a diagram conceptually illustrating an example of processing using a machine-learned model,

FIG. 5 is a diagram conceptually illustrating an example of processing by a subject area detection unit,

FIG. 6 conceptually illustrates an example of a table,

FIG. 7 is a diagram conceptually illustrating an example of processing by an AF area decision unit,

FIG. 8 is a diagram describing a first threshold value used for correction processing by a magnification correction unit,

FIG. 9 is a diagram describing a second threshold value used for correction processing by a magnification correction unit,

FIG. 10 is a diagram illustrating an example of processing by the magnification correction unit,

FIG. 11 is a flowchart illustrating an example of an imaging operation by the imaging apparatus,

FIG. 12 is a diagram illustrating an example of a plurality of tables stored in a memory in a first modification example,

FIG. 13 is a diagram illustrating magnification acquisition processing according to the first modification example,

FIG. 14 is a diagram illustrating magnification correction processing according to a second modification example, and

FIG. 15 is a diagram illustrating magnification correction processing according to a third modification example.

### DETAILED DESCRIPTION

An example of an embodiment according to the technology of the present disclosure will be described with reference to the accompanying drawings.

First, the terms to be used in the following description will be described.

In the following description, “AF” is an abbreviation for “auto focus”. “MF” is an abbreviation for “manual focus”. “IC” is an abbreviation for “integrated circuit”. “CPU” is an abbreviation for “central processing unit”. “ROM” is an abbreviation for “read only memory”. “RAM” is an abbreviation for “random access memory”. “CMOS” is an abbreviation for “complementary metal oxide semiconductor”.

“FPGA” is an abbreviation for “field programmable gate array”. “PLD” is an abbreviation for “programmable logic device”. “ASIC” is an abbreviation for “application specific integrated circuit”. “OVF” is an abbreviation for “optical view finder”. “EVF” is an abbreviation for “electronic view finder”.

As one embodiment of an imaging apparatus, the technology of the present disclosure will be described by using a lens-interchangeable digital camera as an example. Note that the technology of the present disclosure is not limited to the lens-interchangeable type and can also be applied to a lens-integrated digital camera.

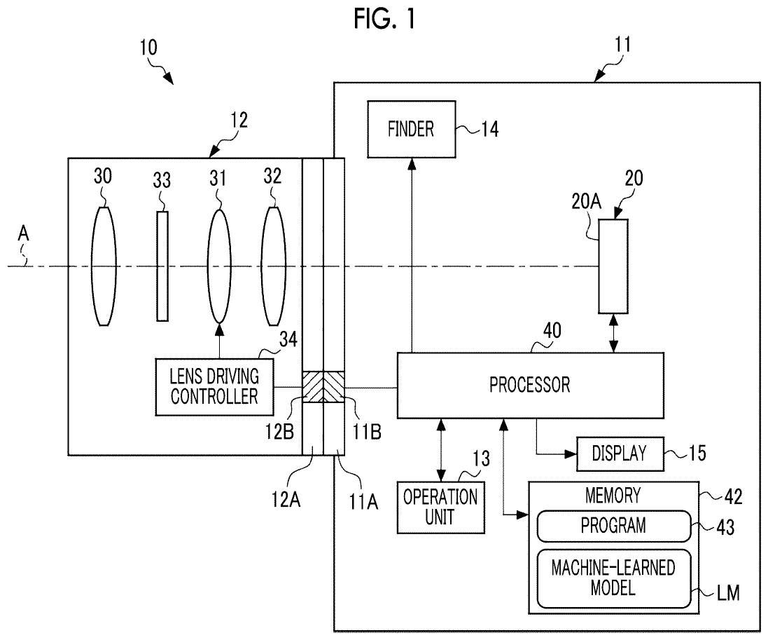

FIG. 1 illustrates an example of a configuration of an imaging apparatus 10. The imaging apparatus 10 is a lens-interchangeable digital camera. The imaging apparatus 10 includes a body 11 and an imaging lens 12 that is interchangeably mounted on the body 11 and includes a focus lens 31. The imaging lens 12 is attached to a front surface side of the body 11 via a camera side mount 11A and a lens side mount 12A.

The body 11 is provided with an operation unit 13 including a dial, a release button, and the like. Examples of an operation mode of the imaging apparatus 10 include a still image capturing mode, a video capturing mode, and an image display mode. The operation unit 13 is operated by a user upon setting the operation mode. In addition, the operation unit 13 is operated by the user in a case of starting the execution of still image capturing or video capturing.

In addition, the operation unit 13 is operated by the user in a case of selecting a focusing mode. The focusing mode includes an AF mode and an MF mode. The AF mode is a mode in which a subject area selected by the user or a subject area automatically detected by the imaging apparatus 10 is set as a focus detection area (hereinafter, referred to as an AF area) and focusing control is performed. The MF mode is a mode in which the user manually performs focusing control by operating a focus ring (not illustrated). In the present embodiment, the subject area and the AF area are respectively set to a rectangle.

The AF mode includes a continuous AF mode (hereinafter, referred to as an AF-C mode) and a single AF mode (hereinafter, referred to as an AF-S mode). The AF-C mode is a mode in which the focusing control is continued (that is, position control of the focus lens 31 is continued) while the release button is half-pressed. Note that the AF-C mode corresponds to a “continuous focusing mode in which continuous focusing operations are performed” according to the technology of the present disclosure. In addition, the continuous focusing operation means that focusing control for a specific subject is automatically repeated over a plurality of frame periods, and a frame period in which focusing control is not performed may be included in a part of the plurality of frame periods.

The AF-S mode is a mode in which focusing control is performed once in response to half-pressing of the release button and a position of the focus lens 31 is fixed while the release button is half-pressed. The AF-C mode and the AF-S mode can be switched by using the operation unit 13.

In addition, in the AF mode, a subject that is a focusing target can be set by using the operation unit 13. The subject that is a focusing target and can be set is an object or a part of an object. The object that is a focusing target includes, for example, a person, an animal (a dog, a cat, and the like), a bird, a train, a car, a motorcycle (a motorbike), a ship, and an airplane. The part that is a focusing target includes, for example, a face of a person, a pupil of a person, a pupil of an animal, or a pupil of a bird. Further, in a case where a pupil is set as a part that is a focusing target, it is possible to set which of a right eye or a left eye is to be prioritized as a subject that is a focusing target.

Further, the body 11 is provided with a finder 14. Here, the finder 14 is a hybrid finder (registered trademark). The hybrid finder refers to, for example, a finder in which an optical view finder (hereinafter, referred to as “OVF”) and an electronic view finder (hereinafter, referred to as “EVF”) are selectively used. The user can observe an optical image or a live view image of a subject projected onto the finder 14 via a finder eyepiece portion (not illustrated).

In addition, a display 15 is provided on a rear surface side of the body 11. The display 15 displays an image based on an imaging signal obtained through imaging, various menu screens, and the like. The user can also observe the live view image projected onto the display 15 instead of the finder 14.

The body 11 and the imaging lens 12 are electrically connected to each other through contact between an electrical contact 11B provided on the camera side mount 11A and an electrical contact 12B provided on the lens side mount 12A.

The imaging lens 12 includes an objective lens 30, a focus lens 31, a rear end lens 32, and a stop 33. Each member is disposed in the order of the objective lens 30, the stop 33, the focus lens 31, and the rear end lens 32 from the objective side along an optical axis A of the imaging lens 12. The objective lens 30, the focus lens 31, and the rear end lens 32 constitute an imaging optical system. The type, number, and arrangement order of the lenses constituting the imaging optical system are not limited to the example illustrated in FIG. 1.

In addition, the imaging lens 12 includes a lens driving controller 34. The lens driving controller 34 includes, for example, a CPU, a RAM, a ROM, and the like. The lens driving controller 34 is electrically connected to a processor 40 inside the body 11 via the electrical contact 12B and the electrical contact 11B.

The lens driving controller 34 drives the focus lens 31 and the stop 33 based on a control signal transmitted from the processor 40. The lens driving controller 34 performs drive control of the focus lens 31 based on a control signal for focusing control that is transmitted from the processor 40, in order to adjust a position of the focus lens 31.

The stop 33 has an opening in which an opening diameter is variable with the optical axis A as a center. The lens driving controller 34 performs drive control of the stop 33 based on a control signal for stop adjustment that is transmitted from the processor 40, in order to adjust an amount of light incident on a light-receiving surface 20A of an imaging sensor 20.

Further, the imaging sensor 20, the processor 40, and a memory 42 are provided inside the body 11. The operations of the imaging sensor 20, the memory 42, the operation unit 13, the finder 14, and the display 15 are controlled by the processor 40.

The processor 40 includes, for example, a CPU, a RAM, a ROM, and the like. In such a case, the processor 40 executes various types of processing based on a program 43 stored in the memory 42. Note that the processor 40 may be configured by an assembly of a plurality of IC chips. In addition, the memory 42 stores a machine-learned model LM for performing subject detection, the machine-learned model being obtained by performing machine learning.

The imaging sensor 20 is, for example, a CMOS-type image sensor. The imaging sensor 20 is disposed such that the optical axis A is orthogonal to the light-receiving surface 20A and the optical axis A is located at the center of the light-receiving surface 20A. Light (subject image) passing through the imaging lens 12 is incident on the light-receiving surface 20A. A plurality of pixels for generating imaging signals through photoelectric conversion are formed on the light-receiving surface 20A. The imaging sensor 20 generates and outputs image data PD including an imaging signal by photoelectrically converting light incident on each pixel. Note that the imaging sensor 20 is an example of an “imaging element” according to the technology of the present disclosure.

In addition, a color filter array of a Bayer array is disposed on the light-receiving surface 20A of the imaging sensor 20, and a color filter of any one of red (R), green (G), or blue (B) is disposed to face each pixel. Note that some of the plurality of pixels arranged on the light-receiving surface of the imaging sensor 20 are phase difference detection pixels that output a phase difference detection signal for performing focusing control.

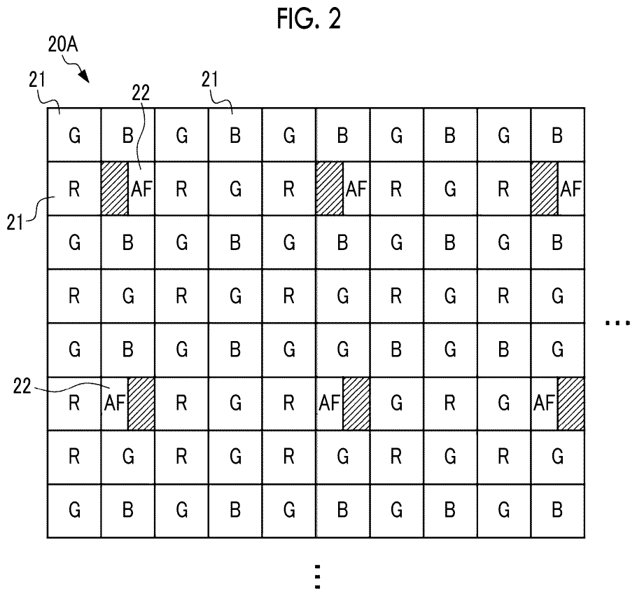

FIG. 2 illustrates an example of the light-receiving surface 20A of the imaging sensor 20. A plurality of imaging pixels 21 and a plurality of phase difference detection pixels 22 are arranged on the light-receiving surface 20A. The imaging pixel 21 is a pixel in which the color filter is disposed. The imaging pixel 21 receives a luminous flux passing through the entire region of the aperture of the imaging optical system. The phase difference detection pixel 22 receives a luminous flux passing through a region of the half of the aperture of the imaging optical system. In the example illustrated in FIG. 2, some of the G pixels that are diagonally disposed are replaced with the phase difference detection pixels 22 in the Bayer array. The phase difference detection pixels 22 are disposed on the light-receiving surface 20A at regular intervals in a vertical direction and a horizontal direction. The phase difference detection pixels 22 are divided into first phase difference detection pixels that receive a luminous flux passing through a region of the half of the aperture and second phase difference detection pixels that receive a luminous flux passing through a region of the other half of the aperture.

The plurality of imaging pixels 21 output an imaging signal for generating an image of the subject. The plurality of phase difference detection pixels 22 output a phase difference detection signal. The image data PD output from the imaging sensor 20 includes the imaging signal and the phase difference detection signal.

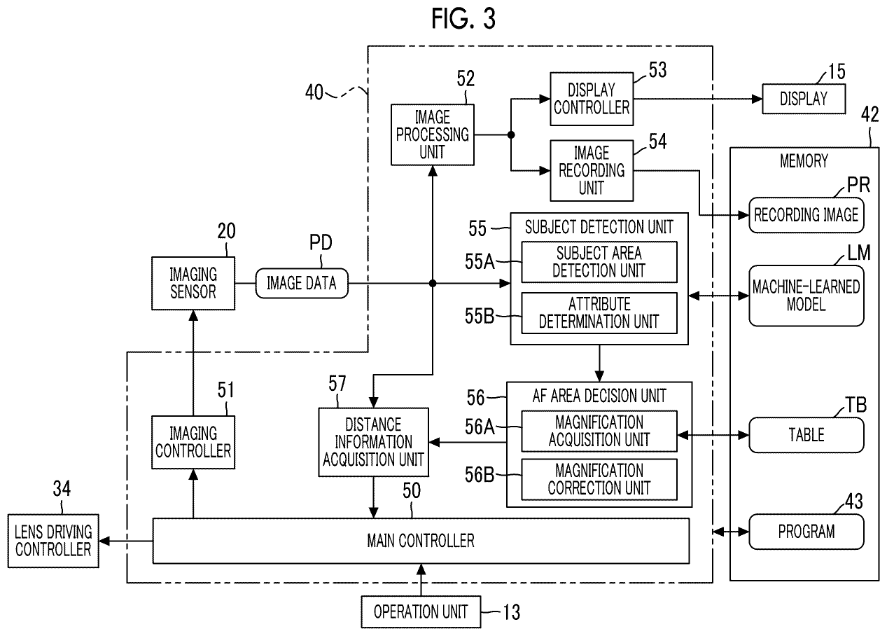

FIG. 3 illustrates an example of a functional configuration of the processor 40. The processor 40 implements various functional units by executing processing in accordance with the program 43 stored in the memory 42. As illustrated in FIG. 3, the processor 40 implements, for example, a main controller 50, an imaging controller 51, an image processing unit 52, a display controller 53, an image recording unit 54, a subject detection unit 55, an AF area decision unit 56, and a distance information acquisition unit 57.

The main controller 50 comprehensively controls operations of the imaging apparatus 10 based on instruction signals input from the operation unit 13. The imaging controller 51 executes imaging processing of causing the imaging sensor 20 to perform an imaging operation by controlling the imaging sensor 20. The imaging controller 51 drives the imaging sensor 20 in the still image capturing mode or the video capturing mode. The imaging sensor 20 outputs the image data PD generated by performing imaging via the imaging lens 12. The image data PD output from the imaging sensor 20 is supplied to the image processing unit 52, the subject detection unit 55, and the distance information acquisition unit 57.

The image processing unit 52 acquires the image data PD output from the imaging sensor 20, and performs, on the image data PD, image processing including white balance correction, gamma correction processing, and the like.

The display controller 53 displays, on the display 15, a live view image based on the image data PD obtained by performing image processing by the image processing unit 52. The image recording unit 54 records, as a recording image PR, the image data PD that is obtained by performing image processing by the image processing unit 52 in the memory 42 in a case where the release button is fully pressed.

The subject detection unit 55 reads the machine-learned model LM stored in the memory 42. The subject detection unit 55 performs detection processing of detecting a subject area including a subject that is a focusing target from the image data PD by using the machine-learned model LM, and determination processing of determining an attribute of the subject by using the machine-learned model LM. Specifically, the subject detection unit 55 includes a subject area detection unit 55A that performs detection processing and an attribute determination unit 55B that performs determination processing. Note that the subject area is an example of a “first range” according to the technology of the present disclosure. In addition, the attribute is, for example, a category for classifying a type of the subject.

The machine-learned model LM is configured by, for example, a convolutional neural network, detects an object appearing in the image data PD, and outputs detection information of the object together with an attribute and a detection score of the detected object. The machine-learned model LM can detect two or more types of objects. The objects detected by the machine-learned model LM are, for example, two or more types of objects selected from a person, an animal, a bird, a train, a car, a motorcycle, a ship, and an airplane.

In addition, the machine-learned model LM detects a part of the object, and outputs detection information of the part of the object together with an attribute and a detection score of the detected part of the object. The machine-learned model LM can detect parts of two or more types of objects. The parts of the objects detected by the machine-learned model LM are, for example, parts of two or more types of objects selected from a face of a person, a pupil of a person, a pupil of an animal, and a pupil of a bird.

The subject area detection unit 55A detects a region including the subject that is a focusing target, as a subject area, from the object and the part of the object that are included in the detection information, based on the detection information output from the machine-learned model LM. The subject area detection unit 55A detects, as a subject area, a region including an object or a part of an object that matches the type of the subject which is a focusing target set by using the operation unit 13, from the object and the part of the object included in the detection information. For example, in a case where “right eye of person” is set as a type of a subject that is a focusing target, the subject area detection unit 55A sets a region including a right eye of a person as a subject area.

In addition, in a case where a plurality of objects having an attribute or a plurality of parts of the objects are present, the subject area detection unit 55A sets, as a subject area, a region including an object or a part of an object that is closest to the center of the image represented by the image data PD or the AF area which is initially set.

The attribute determination unit 55B determines an attribute of the subject included in the subject area detected by the subject area detection unit 55A. Specifically, the attribute determination unit 55B determines whether an attribute of the subject corresponds to which object among the two or more types of objects, or whether an attribute of the subject corresponds to which part of which object among the two or more types of objects. For example, in a case where the subject included in the subject area detected by the subject area detection unit 55A is a pupil, it is determined whether the pupil is a pupil of a person, an animal, or a bird.

The AF area decision unit 56 decides an AF area based on the subject area detected by the subject area detection unit 55A and the attribute determined by the attribute determination unit 55B. The AF area is a region for acquiring distance information of the subject. Note that the AF area is an example of a “second range” according to the technology of the present disclosure.

The AF area decision unit 56 basically sets the subject area detected by the subject area detection unit 55A as an AF area. On the other hand, the AF area decision unit 56 reduces or enlarges the AF area based on the attribute determined by the attribute determination unit 55B. That is, the AF area decision unit 56 decides whether a size of the AF area is set to be smaller or to be larger than a size of the subject area based on the attribute (that is, whether the second range is set to be within the first range or to exceed the first range). Note that the AF area decision unit 56 may decide the AF area to be the same size as the subject area (that is, the second range is set to be the same size as the first range).

Specifically, the AF area decision unit 56 includes a magnification acquisition unit 56A and a magnification correction unit 56B. The magnification acquisition unit 56A acquires a magnification corresponding to the attribute of the subject that is determined by the attribute determination unit 55B by referring to a table TB stored in the memory 42. In the table TB, magnifications are set for attributes of various types of subjects.

The magnification correction unit 56B corrects the magnification acquired by the magnification acquisition unit 56A. That is, the magnification correction unit 56B corrects the size of the AF area. In the present embodiment, the magnification correction unit 56B corrects the magnification by using a first threshold value and a second threshold value. Here, the second threshold value is smaller than the first threshold value. The magnification correction unit 56B corrects the magnification such that the AF area is reduced in a case where the size of the AF area that is obtained by multiplying the magnification acquired by the magnification acquisition unit 56A exceeds the first threshold value. In addition, the magnification correction unit 56B corrects the magnification such that the AF area is enlarged in a case where the size of the AF area that is obtained by multiplying the magnification acquired by the magnification acquisition unit 56A is smaller than the second threshold value.

As described above, the AF area decision unit 56 decides the size of the AF area with respect to the subject area, according to the magnification that is acquired by the magnification acquisition unit 56A and is corrected by the magnification correction unit 56B.

The distance information acquisition unit 57 performs acquisition processing of acquiring distance information of the subject in the AF area decided by the AF area decision unit 56. Specifically, the distance information acquisition unit 57 acquires a phase difference detection signal from a portion of the image data PD that is output from the imaging sensor 20 and corresponds to the AF area, and calculates a defocus amount as distance information based on the acquired phase difference detection signal. The defocus amount represents a deviation amount from the focusing position of the focus lens 31.

The main controller 50 performs focusing processing of bringing the subject included in the AF area into a focusing state by moving the position of the focus lens 31 via the lens driving controller 34 based on the distance information calculated by the distance information acquisition unit 57. As described above, in the present embodiment, focusing control using a phase difference detection method is performed.

The main controller 50 also performs exposure control in addition to the focusing control. The exposure control is control of obtaining an exposure evaluation value from the image data PD by computation and adjusting exposure (a shutter speed and an F number) based on the exposure evaluation value.

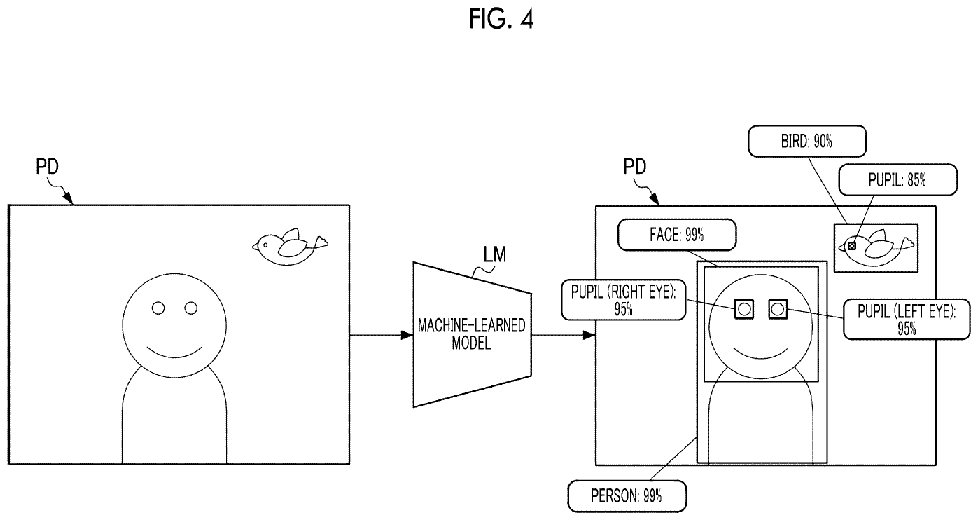

FIG. 4 conceptually illustrates an example of processing by the machine-learned model LM. The image data PD is input to the machine-learned model LM. The machine-learned model LM detects a region including an object appearing in the image data PD and a region including a part of the object, and outputs the regions together with the attribute and the detection score. The detection score represents the reliability of the attribute of the detected object or the detected part of the object. In the example illustrated in FIG. 4, “person” and “bird” are detected as the object, and “face of person”, “pupil of person (right eye)”, “pupil of person (left eye)”, and “eye of bird” are detected as the part of the object. The detection score is represented by a percentage. As the detection score is closer to 100%, the reliability of the determination of the attribute is higher. The detection score is an example of “reliability of determination of attribute” according to the technology of the present disclosure. Note that the detection score may not be displayed on the screen. In addition, a detection frame for changing a color or a shape based on a value of the detection score may be displayed on the screen.

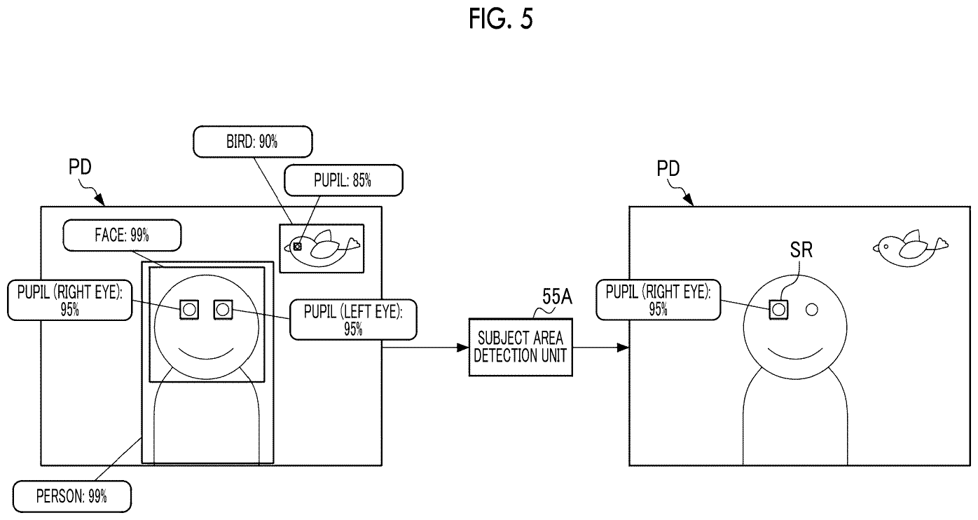

FIG. 5 conceptually illustrates an example of processing by the subject area detection unit 55A. The subject area detection unit 55A detects a subject area including a subject that is a focusing target from the plurality of objects and the parts of the objects that are detected by the machine-learned model LM. The example illustrated in FIG. 5 illustrates a case where “right eye of person” is set as a type of a subject that is a focusing target. In the present example, the subject area detection unit 55A detects a region including the pupil (right eye) of the person as a subject area SR. The attribute determination unit 55B determines an attribute of the subject included in the subject area SR. In the present example, the attribute determined by the attribute determination unit 55B is “pupil of person”.

The machine-learned model LM is generated by performing machine learning on a machine learning model by using a large number of training data in a learning phase. The machine learning model obtained by performing machine learning in the learning phase is stored in the memory 42, as the machine-learned model LM. Note that the learning processing of the machine learning model is performed by, for example, an external device.

The machine-learned model LM is not limited to a model configured as software, and may be configured by hardware such as an IC chip. In addition, the machine-learned model LM may be configured by a set of a plurality of IC chips.

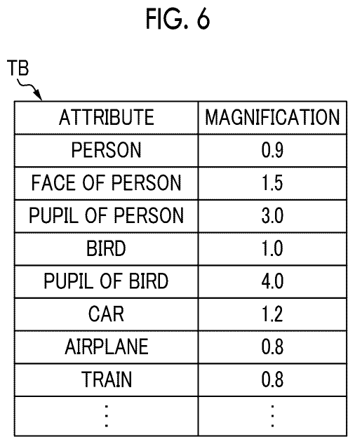

FIG. 6 conceptually illustrates an example of the table TB. In the table TB, magnifications are set for attributes of various types of objects and parts of the objects. The magnification acquisition unit 56A of the AF area decision unit 56 acquires a magnification corresponding to the attribute determined by the attribute determination unit 55B from the table TB. In the present example, the magnification acquisition unit 56A acquires a magnification “3.0” corresponding to the pupil of the person.

In the table TB, the magnification is decided in advance based on a difficulty in predicting a movement of the object and a size of the object or the part of the object. In the table TB, basically, a larger magnification is associated with an object for which it is more difficult to predict the movement. In addition, in the table TB, basically, a larger magnification is associated with an object or a part of the object that has a smaller size.

For an object, such as an animal or a bird, for which it is difficult to predict the movement, in a case where the subject area is used as the AF area, the object is likely to move outside the AF area after the next frame period. Therefore, in a case of an object for which it is difficult to predict the movement, the AF area is enlarged by increasing the magnification, and thus the object is likely to be included in the AF area even in a case where the object moves. In addition, since the part of the object, such as the pupil, is small, the subject area is small. Therefore, similarly to the above case, the AF area is enlarged by increasing the magnification, and thus the part of the object is likely to be included in the AF area.

An airplane, a train, and the like are moving objects that move at a high speed, but in most cases, the moving object is imaged from a long distance and the movement of the moving object can be easily predicted. Therefore, the magnification is set to “1.0” such that the subject area is used as it is as the AF area.

In addition, in the table TB, the magnification for a pupil of a bird is set to be larger than the magnification for a pupil of a person. This is because it is more difficult to predict a movement of a bird than a movement of a person and a pupil of a bird is smaller than a pupil of a person. In this way, it is also preferable to vary the magnification in order to vary the size of the AF area in a case where the attribute is determined to be a first part of a first object and in a case where the attribute is determined to be a first part of a second object. In the present example, the first object is “person” and the second object is “bird”. In addition, the first part is “pupil” for both the first object and the second object.

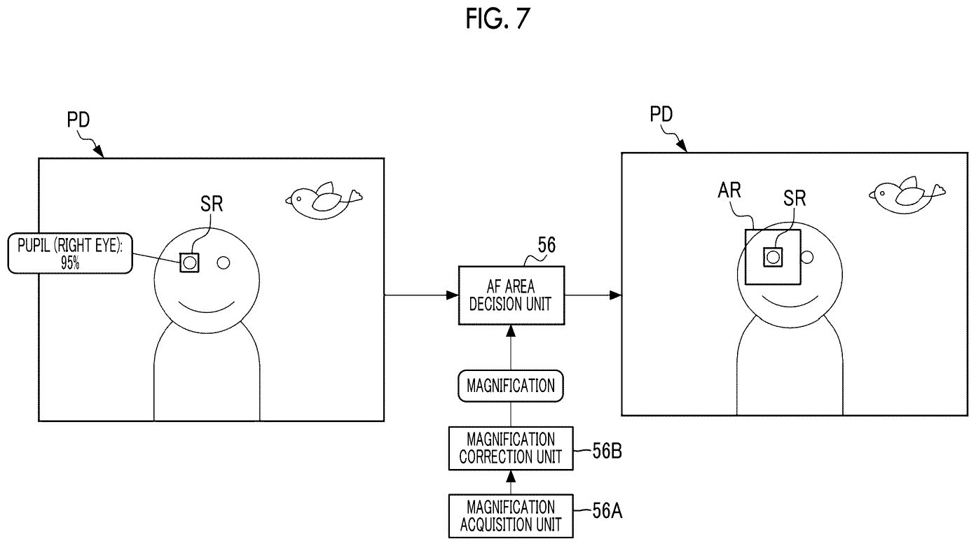

FIG. 7 conceptually illustrates an example of processing by the AF area decision unit 56. The AF area decision unit 56 decides a size of the AF area AR according to the magnification that is acquired by the magnification acquisition unit 56A and is corrected by the magnification correction unit 56B. In the example illustrated in FIG. 7, the AF area decision unit 56 enlarges the AF area AR to a size three times the size of the subject area SR.

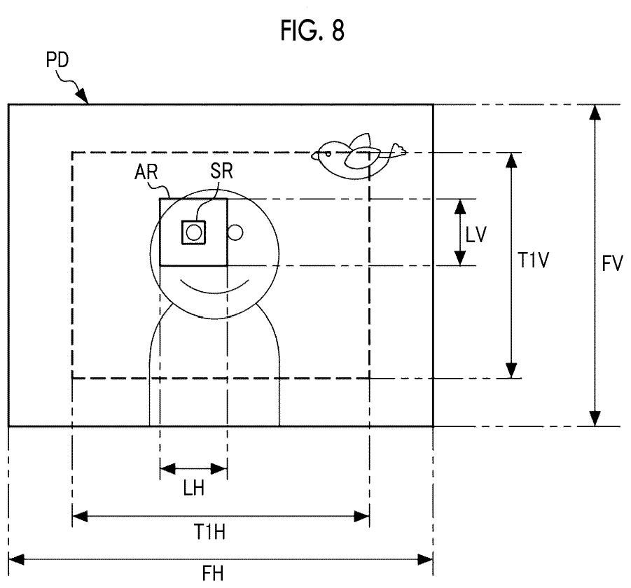

FIG. 8 is a diagram for describing a first threshold value used for the correction processing by the magnification correction unit 56B. The magnification correction unit 56B compares a length LH of the AF area AR in the horizontal direction with a first threshold value T1H, the length LH being obtained by multiplying the magnification acquired by the magnification acquisition unit 56A, and in a case where LH>T1H, corrects the magnification in the horizontal direction such that LH≤T1H. Similarly, the magnification correction unit 56B compares a length LV of the AF area AR in the vertical direction with a first threshold value T1V, the length LV being obtained by multiplying the magnification acquired by the magnification acquisition unit 56A, and in a case where LV>T1V, corrects the magnification in the vertical direction such that LV≤T1V.

As described above, in the example illustrated in FIG. 8, the first threshold values are set for each of the horizontal direction and the vertical direction of the image data PD. The first threshold value T1H is defined with reference to a length FH of the image data PD in the horizontal direction. For example, the first threshold value T1H is a length of 70% of the length FH. Similarly, the first threshold value T1V is defined with reference to a length FV of the image data PD in the vertical direction. For example, the first threshold value T1V is a length of 70% of the length FV.

In a case where the AF area is too large, a processing time required for focusing control is lengthened. For this reason, in a case where the AF area is larger than the first threshold value, the AF area is reduced such that the processing time is shortened. In addition, in a case where the AF area is too large, an object other than the subject that is a focusing target is likely to be included in the AF area. As described above, in a case where an object other than the subject that is a focusing target is included in the AF area, the focusing accuracy is decreased. Therefore, there is also an advantage that the focusing accuracy is improved by reducing the AF area.

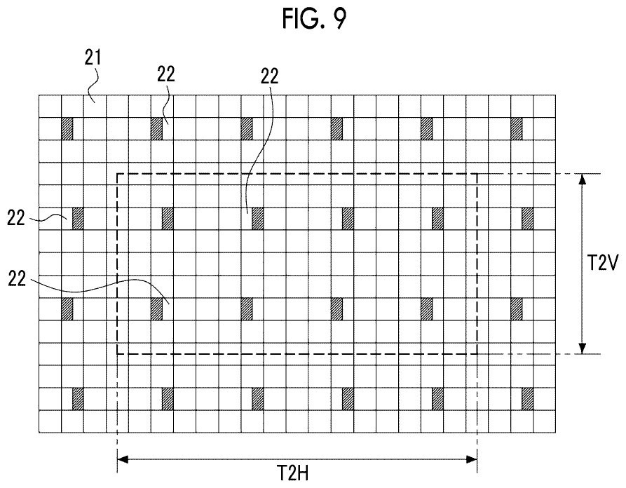

FIG. 9 is a diagram for conceptually describing a second threshold value used for the correction processing by the magnification correction unit 56B. In the example illustrated in FIG. 9, a second threshold value T2H in the horizontal direction and a second threshold value T2V in the vertical direction are decided based on the number of the phase difference detection pixels 22 in the horizontal direction and the vertical direction. In a case where the AF area is too small, the number of the phase difference detection pixels 22 included in the AF area is reduced. As a result, the calculation accuracy of the distance information is decreased, and the focusing accuracy is decreased.

In the present example, the second threshold value T2H is set as a length including four phase difference detection pixels 22 arranged in the horizontal direction. In addition, the second threshold value T2V is set as a length including two phase difference detection pixels 22 arranged in the vertical direction. The phase difference detection pixel 22 detects a phase difference in the horizontal direction. Thus, it is preferable that T2H>T2V.

The magnification correction unit 56B compares a length LH of the AF area AR in the horizontal direction with a second threshold value T2H, the length LH being obtained by multiplying the magnification acquired by the magnification acquisition unit 56A, and in a case where LH<T2H, corrects the magnification in the horizontal direction such that LH>T2H. Similarly, the magnification correction unit 56B compares a length LV of the AF area AR in the vertical direction with a second threshold value T2V, the length LV being obtained by multiplying the magnification acquired by the magnification acquisition unit 56A, and in a case where LV<T2V, corrects the magnification in the vertical direction such that LV>T2V.

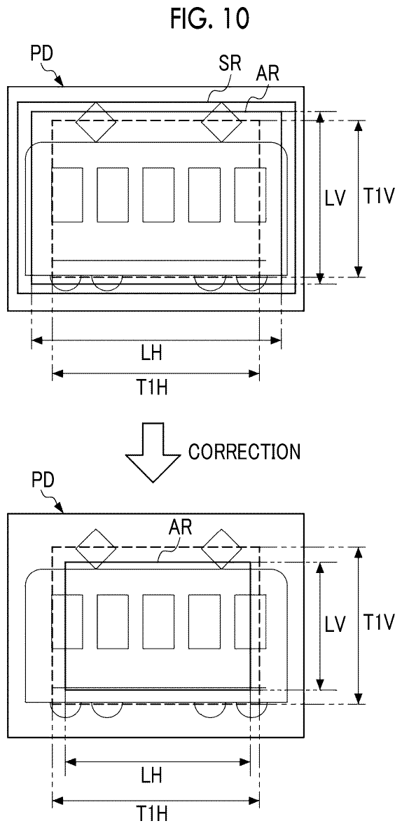

FIG. 10 illustrates an example of processing by the magnification correction unit 56B. In the example illustrated in FIG. 10, the length LH of the AF area AR in the horizontal direction and the length LV of the AF area AR in the vertical direction, which are obtained by multiplying the magnification acquired by the magnification acquisition unit 56A by the size of the subject area SR, respectively exceed the first threshold value T1H and the first threshold value T1V. In the present example, the magnification correction unit 56B corrects the magnification such that LH<T1H and LV<T1V.

Note that the magnification correction unit 56B does not perform the correction processing in a case where a relationship of T2H<LH<T1H and T2V<LV<T1V is satisfied before the magnification correction unit 56B performs the correction. In addition, in the examples illustrated in FIG. 8 to FIG. 10, T1H #T1V and T2H/T2V, but T1H =T1V and T2H=T2V may be applied.

In addition, in the example illustrated in FIG. 9, the second threshold value T2H and the second threshold value T2V are decided based on the number of the phase difference detection pixels 22. On the other hand, in a case where the AF area is displayed on the display 15 or the finder 14, the second threshold values may be decided based on a minimum size that can be recognized as a rectangular region by the user.

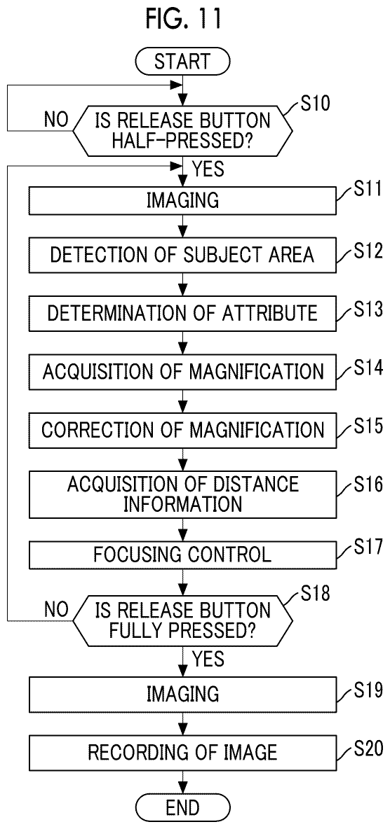

FIG. 11 is a flowchart illustrating an example of an imaging operation by the imaging apparatus 10. FIG. 11 illustrates a case where the AF-C mode is selected as the focusing mode and a mode in which the imaging apparatus 10 automatically detects a subject area is selected.

First, the main controller 50 determines whether or not the release button is half-pressed by the user (step S10). In a case where the release button is half-pressed (YES in step S10), the main controller 50 controls the imaging controller 51 to cause the imaging sensor 20 to perform an imaging operation (step S11). The image data PD output from the imaging sensor 20 is input to the subject detection unit 55.

The subject area detection unit 55A of the subject detection unit 55 performs detection processing of detecting a subject area, which is the first range including a subject that is a focusing target, from the image data PD by using the machine-learned model LM (step S12). The attribute determination unit 55B performs determination processing of determining an attribute of the subject included in the subject area detected in step S12 (step S13).

The magnification acquisition unit 56A of the AF area decision unit 56 acquires a magnification corresponding to the attribute determined in step S13 by referring to the table TB (step S14). The magnification correction unit 56B performs correction processing of correcting the magnification acquired in step S14 (step S15). Note that the magnification correction unit 56B does not perform the correction processing in a case where correction of the magnification is not necessary. The AF area that is the second range is decided according to the magnification which is acquired in step S14 and is corrected in step S15 and a size of the first range.

The distance information acquisition unit 57 performs acquisition processing of acquiring distance information of the subject in the AF area (step S16). The main controller 50 performs focusing processing of bringing the subject included in the AF area into a focusing state based on the distance information acquired in step S16 (step S17).

The main controller 50 determines whether or not the release button is fully pressed by the user (step S18). In a case where the release button is not fully pressed (that is, in a case where half-pressing of the release button is continued) (NO in step S18), the main controller 50 returns the processing to step S11, and causes the imaging sensor 20 to perform an imaging operation again. The processing of step S11 to step S17 is repeatedly executed until the main controller 50 determines in step S18 that the release button is fully pressed.

In a case where the release button is fully pressed (YES in step $18), the main controller 50 causes the imaging sensor 20 to perform an imaging operation (step S19). The image recording unit 54 records the image data PD, which is output from the imaging sensor 20 and then is obtained by performing image processing by the image processing unit 52, in the memory 42, as a recording image PR (step S20).

In the flowchart, step S11 corresponds to an “imaging step” according to the technology of the present disclosure. Step S12 corresponds to a “detection step” according to the technology of the present disclosure. Step S13 corresponds to a “determination step” according to the technology of the present disclosure. Step S14 and step S15 correspond to a “decision step” according to the technology of the present disclosure. Step S15 corresponds to a “correction step” according to the technology of the present disclosure. Step S16 corresponds to an “acquisition step” according to the technology of the present disclosure. Step S17 corresponds to a “focusing step” according to the technology of the present disclosure.

Note that, although not illustrated in the flowchart, the image represented by the image data PD may be displayed on the display 15 or the finder 14 while the release button is half-pressed. In this case, a frame indicating the AF area may be displayed on the image. A size of the frame may be different from the size of the AF area. For example, in a case where the size of the frame indicating the display area is increased, the user can easily determine the presence or absence of the subject. Thus, the frame of the display area may be displayed to be larger than the AF area.

As described above, according to the imaging apparatus 10 of the present disclosure, based on the attribute of the subject that is included in the subject area and is a focusing target, it is decided whether the size of the AF area is set to be within the subject area or to exceed the subject area. Thus, the focusing accuracy on the subject that is a focusing target can be improved.

Hereinafter, various modification examples of the embodiment will be described.

### First Modification Example

In the embodiment, one table TB is stored in the memory 42. On the other hand, a plurality of tables may be stored in the memory 42, and the magnification acquisition unit 56A may be configured to select a table used for acquisition of the magnification.

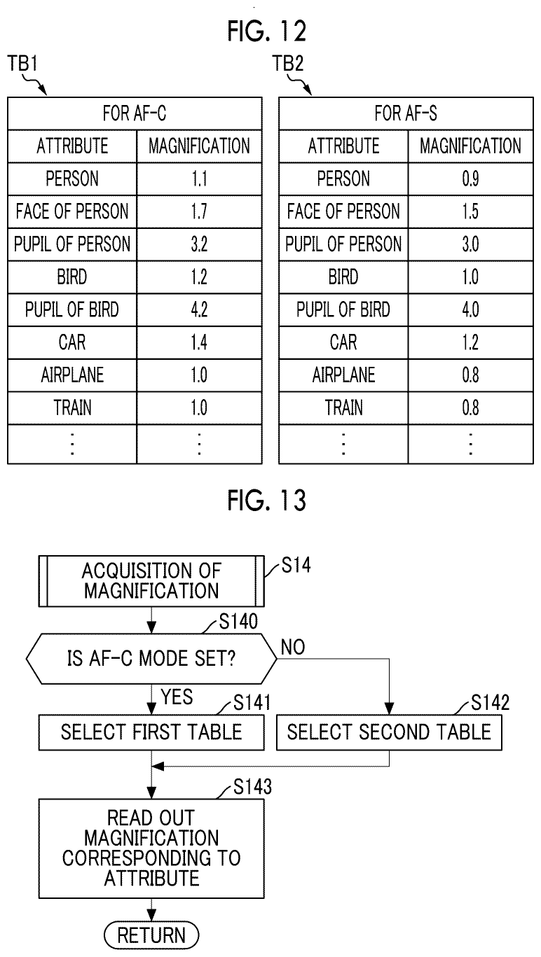

FIG. 12 illustrates an example of a plurality of tables stored in the memory 42 in the first modification example. A first table TB1 is a table for the AF-C mode. A second table TB2 is a table for the AF-S mode. In the first table TB1, as compared with the second table TB2, a larger magnification is set for the same attribute. This is because, in general, the AF-C mode is used in a scene in which the movement of the subject is larger than in the AF-S mode.

FIG. 13 illustrates magnification acquisition processing according to the first modification example. In the present modification example, in step S14 illustrated in FIG. 11, the magnification acquisition unit 56A determines whether or not the AF-C mode is set (step S140). In a case where the AF-C mode is set (YES in step S140), the magnification acquisition unit 56A selects the first table TB1 (step S141). In a case where the AF-C mode is not set (that is, in a case where the AF-S mode is set) (NO in step S140), the magnification acquisition unit 56A selects the second table TB2 (step S142).

The magnification acquisition unit 56A reads out the magnification corresponding to the attribute determined in step S13, from the first table TB1 selected in step S141 or the second table TB2 selected in step S142 (step S143).

As described above, the imaging apparatus 10 can selectively execute the AF-C mode as the focusing mode, and in the decision processing according to the present modification example, the size of the AF area varies depending on whether or not the focusing mode is the AF-C mode. Thereby, the size of the AF area is optimized according to the focusing mode, and the focusing accuracy is further improved.

### Second Modification Example

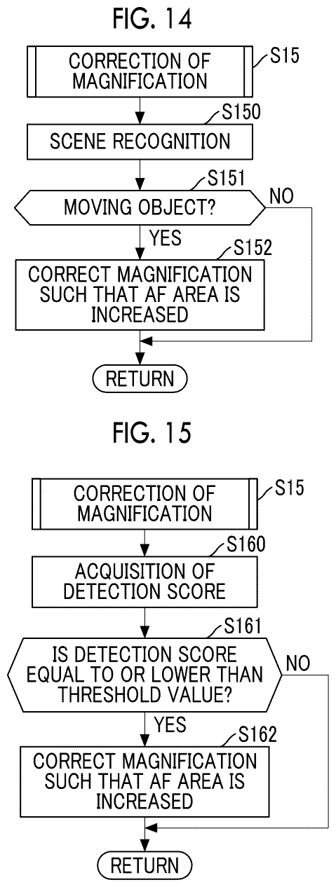

FIG. 14 illustrates magnification correction processing according to a second modification example. In the present modification example, in step S15 illustrated in FIG. 11, the magnification correction unit 56B performs scene recognition based on the image data PD (step S150). In the scene recognition, the magnification correction unit 56B may perform scene recognition in consideration of the attribute of the subject that is determined by the attribute determination unit 55B. In addition, during the scene recognition, moving object determination for determining whether or not the subject is a moving object that actually moves is performed.

The magnification correction unit 56B determines whether or not the subject that is a focusing target is a moving object (step S151). In a case where the subject that is a focusing target is a moving object (YES in step S151), the magnification correction unit 56B corrects the magnification such that the AF area is increased (step S152). In a case where the subject that is a focusing target is not a moving object (NO in step S151), the magnification correction unit 56B does not perform correction.

Note that the magnification correction unit 56B may correct the magnification such that the AF area is reduced in a case where the subject that is a focusing target is not a moving object.

### Third Modification Example

FIG. 15 illustrates magnification correction processing according to a third modification example. In the present modification example, in step S15 illustrated in FIG. 11, the magnification correction unit 56B acquires a detection score for the attribute of the subject that is determined by the attribute determination unit 55B (step S160). The detection score represents the reliability of determination of the attribute.

The magnification correction unit 56B determines whether or not the detection score is equal to or lower than a threshold value (step S161). In a case where the detection score is equal to or lower than the threshold value (YES in step S161), the magnification correction unit 56B corrects the magnification such that the AF area is increased (step S162). In a case where the detection score is not equal to or lower than the threshold value (NO in step S161), the magnification correction unit 56B does not perform correction.

Note that the magnification correction unit 56B may correct the magnification such that the AF area is reduced in a case where the detection score is not equal to or lower than the threshold value.

In addition, the magnification correction unit 56B may perform magnification correction processing with reference to a state of the subject that is a focusing target. The state of the subject is brightness of the subject, a color of the subject, and the like. The magnification correction unit 56B corrects the magnification such that the AF area is increased, for example, in a case where brightness of the subject is equal to or lower than a certain value. This is because, in a scene where the subject is dark, the focusing accuracy is decreased in a case where the AF area is small. The brightness of the subject can be obtained by using the exposure evaluation value calculated by the main controller 50 during the exposure control.

In the second and third modification examples, the magnification correction unit 56B performs primary correction processing with reference to the magnification for determining the size of the AF area, the determination result as to whether or not the subject is a moving object, the value of the detection score, or the state of the subject. In addition, as in the example illustrated in FIG. 10, the magnification correction unit 56B may perform secondary correction processing based on the first threshold value or the second threshold value for the magnification such that the size of the AF area obtained by performing the primary correction processing is within a range defined by the first threshold value and the second threshold value.

### Other Modification Examples

In the embodiment, the subject detection unit 55 performs the detection processing and the determination processing by using the machine-learned model LM. On the other hand, the detection processing and the determination processing may be performed by image analysis using an algorithm without being limited to the machine-learned model LM.

In addition, in the embodiment, the main controller 50 performs focusing control using a phase difference detection method based on the phase difference detection signal output from the plurality of phase difference detection pixels 22. On the other hand, a contrast detection method based on contrast of the image data PD may be performed. In the contrast detection method, the distance information acquisition unit 57 acquires contrast of a part of the image data PD corresponding to the AF area, as the distance information.

Note that the technology of the present disclosure is not limited to the digital camera and can also be applied to electronic devices such as a smartphone and a tablet terminal having an imaging function.

In the above-described embodiment, various processors to be described below can be used as the hardware structure of the controller using the processor 40 as an example. The above-described various processors include not only a CPU which is a general-purpose processor that functions by executing software (programs) but also a processor that has a changeable circuit configuration after manufacturing, such as an FPGA. The FPGA includes a dedicated electrical circuit that is a processor which has a dedicated circuit configuration designed to execute specific processing, such as PLD or ASIC, and the like.

The controller may be configured by one of these various processors or a combination of two or more of the processors of the same type or different types (for example, a combination of a plurality of FPGAs or a combination of a CPU and an FPGA). Alternatively, a plurality of controllers may be configured with one processor.

A plurality of examples in which a plurality of controllers are configured as one processor can be considered. As a first example, there is an aspect in which one or more CPUs and software are combined to configure one processor and the processor functions as a plurality of controllers, as represented by a computer such as a client and a server. As a second example, there is an aspect in which a processor that implements the functions of the entire system, which includes a plurality of controllers, with one IC chip is used, as represented by system on chip (SOC). In this way, the controller can be configured by using one or more of the above-described various processors as the hardware structure.

Furthermore, more specifically, it is possible to use an electrical circuit in which circuit elements such as semiconductor elements are combined, as the hardware structure of these various processors.

The described contents and the illustrated contents are the detailed description of the parts according to the technology of the present disclosure, and are merely examples of the technology of the present disclosure. For example, the descriptions related to the configuration, the function, the operation, and the effect are descriptions related to examples of a configuration, a function, an operation, and an effect of a part according to the technique of the present disclosure. Therefore, it goes without saying that, in the described contents and illustrated contents, unnecessary parts may be deleted, new components may be added, or replacements may be made without departing from the spirit of the technique of the present disclosure. Further, in order to avoid complications and facilitate understanding of the part according to the technique of the present disclosure, in the described contents and illustrated contents, descriptions of technical knowledge and the like that do not require particular explanations to enable implementation of the technique of the present disclosure are omitted.

All documents, patent applications, and technical standards described in this specification are incorporated herein by reference to the same extent as in a case where each document, each patent application, and each technical standard are specifically and individually described by being incorporated by reference.

What is claimed is:

1. An imaging method comprising:
an imaging step of generating image data by an imaging element;
a detection step of detecting a first range including a subject that is a focusing target from the image data;
a determination step of determining an attribute of the subject; and
a decision step of deciding whether a size of a second range for acquiring distance information of the subject is set to be within the first range or to exceed the first range, based on the attribute.

2. The imaging method according to claim 1, wherein the detection step and the determination step are performed by using a machine-learned model.

3. The imaging method according to claim 2, further comprising:
an acquisition step of acquiring the distance information of the subject in the second range; and
a focusing step of bringing the subject into a focusing state based on the distance information.

4. The imaging method according to claim 1,
wherein in the determination step, whether the attribute of the subject corresponds to which object among two or more types of objects is determined, or whether the attribute of the subject corresponds to which part of which object among two or more types of objects is determined.

5. The imaging method according to claim 4,
wherein the object is a person, an animal, a bird, a train, a car, a motorcycle, a ship, or an airplane.

6. The imaging method according to claim 4,
wherein in the decision step, the size of the second range varies in a case where it is determined in the determination step that the attribute is a first part of a first object and in a case where it is determined in the determination step that the attribute is a first part of a second object.

7. The imaging method according to claim 3,
wherein in the focusing step, a continuous focusing mode in which a focusing operation is continuously performed is selectively executable as a focusing mode, and
in the decision step, the size of the second range varies depending on whether or not the focusing mode is the continuous focusing mode.

8. The imaging method according to claim 1,
wherein the decision step includes a correction step of correcting the size of the second range.

9. The imaging method according to claim 8,
wherein in the correction step, the size of the second range is corrected based on a state of the subject, whether or not the subject is a moving object, or reliability of determination of the attribute.

10. The imaging method according to claim 8,
wherein in the correction step,
in a case where the size of the second range exceeds a first threshold value, the second range is reduced, and
in a case where the size of the second range is smaller than a second threshold value which is smaller than the first threshold value, the second range is enlarged.

11. An imaging apparatus comprising:
an imaging element that generates image data; and
a processor,
wherein the processor is configured to execute:
detection processing of detecting a first range including a subject that is a focusing target from the image data;
determination processing of determining an attribute of the subject; and
decision processing of deciding whether a size of a second range for acquiring distance information of the subject is set to be within the first range or to exceed the first range, based on the attribute.

12. A non-transitory computer-readable storage medium storing a program causing a computer to execute:
detection processing of detecting a first range including a subject that is a focusing target from the image data;
determination processing of determining an attribute of the subject; and
decision processing of deciding whether a size of a second range for acquiring distance information of the subject is set to be within the first range or to exceed the first range, based on the attribute.
